(19) United States
(12) Patent Application Publication
(10) Pub. No.: US 2005/0144273 A1
(43) Pub. Date: Jun. 30, 2005

(54) Electronic contracts for devices and embedded systems

(76) Inventors: Asit Dan, Pleasantville, NY (US); Daniel M. Dias, Mohegan Lake, NY (US)

Correspondence Address: LAW OFFICE OF IDO TUCHMAN, 69-60 108 STREET, SUITE 503, FOREST HILLS, NY, 11375, US

(21) Appl. No.: 10/727,224

(22) Filed: Dec. 3, 2003

(51) Int. Cl. G06F 15/173

(52) U.S. Cl. 709/224

(57) ABSTRACT

A method, device and program for embedding an agreement between a device provider and a device user in a device. The agreement is embedded in the device by monitoring at least one performance parameter, determining if an event specified in the agreement has occurred based on the parameter, and, if the event occurred, indicating that the event occurred at the device. The device may be further configured to enforce the agreement. For example, enforcing the agreement may include disabling at least some of the capabilities of the device if the event occurred. Conversely, enforcing the agreement may include enabling at least some of the capabilities of the device if the event occurred.

### FIELD OF THE INVENTION

The present invention generally relates to usage agreements, and more particularly to devices configured to operate in accordance with usage agreements between device providers and device users.

### BACKGROUND

Many business transactions involve agreements between two or more parties. An agreement often specifies qualifying conditions to be met by one or both parties. For example, a car warrantee agreement specifies qualifying conditions for the car warrantee to be valid. If the car owner meets the qualifying conditions, the car manufacturer typically repairs or replaces the vehicle at no cost to the car owner. Another example of an agreement is a car rental agreement, where use of an automobile is limited to a finite time period. The qualifying conditions in the car rental agreement is the time period of use.

The qualifying conditions are based on observable metrics or parameters. For example, a warrantee agreement may specify that a warrantee is valid as long as the car is driven less than 60,000 miles or six years. The observable parameters are the miles driven and the age of the car. Similarly, one of the parameters of the car rental agreement includes the length of time the driver is in possession of the car.

An agreement further specifies events triggered based on the observed metrics or parameters. In the warrantee agreement example discussed above, one event is the expiration of the warrantee after the car is driven more than 60,000 miles. In the car rental agreement, an event may be that the car must be returned to the rental agency after three days.

While such conventional agreements for devices are useful, they are often limiting and easy to circumvent. For example, a car manufacturer may want to require its customers to conduct regular oil changes in order to maintain the car warrantee. Such complex requirements are often difficult and expensive to verify.

When an agreement between parties is violated, it is sometimes the case that the non-violating party must sue the violating party to enforce the agreement. For example, if a renter damages a rental car after the agreement expirers, the rental agency may have to sue the renter for compensation. Lawsuits are typically expensive and take considerable time to resolve. In some situations it may be difficult to provide evidence of agreement violation. Furthermore, there may be instances when a desired agreement between the parties is not legally enforceable. Such agreements often fail to meet legal standards or may not conform to statutory requirements. Thus, parities often desire to enforce various agreements, which may not be actionable in court, in an economical manner.

### SUMMARY OF THE INVENTION

In view of the foregoing, the present invention enables device providers and device users to monitor and enforce device agreements at a device. The device may be any device known in the art, such as a car, refrigerator, and entertainment center. The invention also enables agreements to incorporate many parameters that are generally difficult to monitor and enforce in conventional transactions. The parameters can be transmitted to and recorded by the device provider. As a result, the invention offers a flexible and efficient way of constructing, monitoring and enforcing device agreements.

Therefore, one aspect of the invention is a method for embedding an agreement between a device provider and a device user in a device. The method includes monitoring at least one performance parameter, determining if an event specified in the agreement has occurred based on the parameter, and, if the event occurred, indicating that the event occurred at the device. The method may be further configured to enforce the agreement at the device. For example, enforcing the agreement may include disabling at least some of the capabilities of the device if the event occurred. Conversely, enforcing the agreement may include enabling at least some of the capabilities of the device if the event occurred.

Another aspect of the invention is a device having terms of usage set forth in an agreement between a device provider and a device user. The device includes at least one input module configured to monitor at least one parameter. A determining module is configured to determine if an event specified in the agreement has occurred based on the monitored parameter. The device further includes an alert module configured to indicate that the event occurred. In a particular aspect of the invention, the determining module is configured to determine if the event is likely to occur in the near future, and the alert module is configured to indicate that the event is likely to occur in the near future.

Yet another aspect of the invention is a computer program embodied in a tangible media. The computer program includes computer readable program codes configured to cause the program to monitor at least one performance parameter, determine if an event specified in the agreement has occurred based on the parameter, and if the event occurred, indicate that the event occurred at the device.

The foregoing and other features, utilities and advantages of the invention will be apparent from the following more particular description of various embodiments of the invention as illustrated in the accompanying drawings.

### BRIEF DESCRIPTION OF THE DRAWINGS

FIG. 1 shows exemplary system environment contemplated by the present invention.

FIG. 1 shows an exemplary device contemplated by the present invention.

FIG. 3 shows an exemplary process contemplated by one embodiment of the present invention.

### DETAILED DESCRIPTION OF THE INVENTION

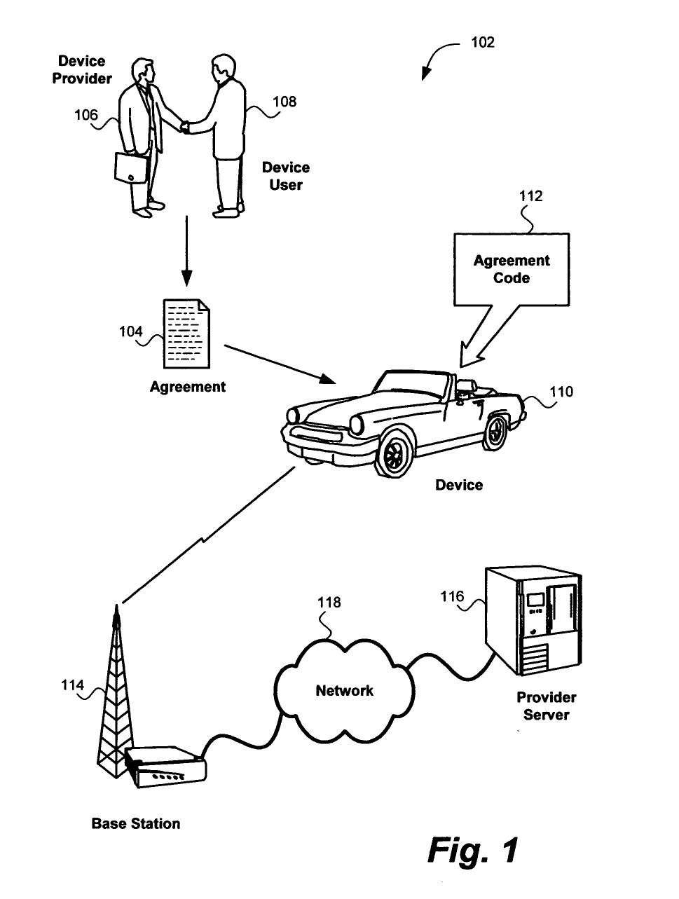

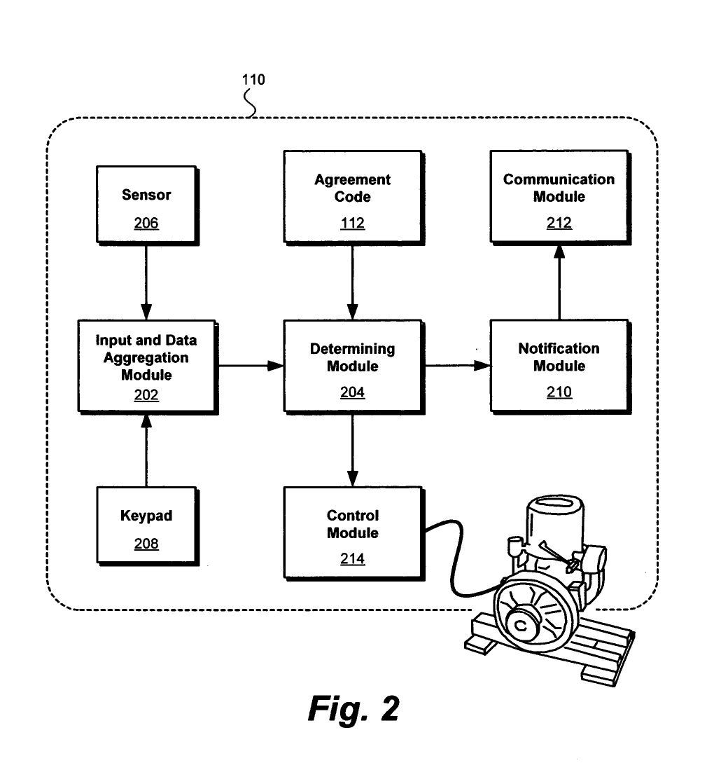

The following description details how the present invention is beneficially employed to embed an agreement between a device provider and a device user into a device. Throughout the description of the invention reference is made to FIGS. 1-3. When referring to the figures, like structures and elements shown throughout are indicated with like reference numerals.

FIG. 1 shows an exemplary system environment 102 contemplated by the present invention. It is initially noted that the environment 102 is presented for illustration purposes only, and is representative of countless system configurations in which the invention may be implemented. Thus, the present invention should not be considered limited to the environment configuration shown herein. The environment 102 includes an agreement 104 entered into by a device provider 106 and a device user 108. The device provider 104 and/or the device user 108 may be individuals, businesses, public or private institutions, governmental agencies, or other entities.

In general, the device provider 106 supplies a device 110 to the device user 108. The device user 108 may directly or indirectly purchase, lease, borrow, or otherwise take possession of the device 110 from the device provider 106. Furthermore, the agreement 104 includes subject matter about a device 110. For example, the agreement 104 may include terms about the use, tampering, or service of the device 110. In general, the agreement 104 stipulates various events that are triggered based on one or more measurable parameters.

It is contemplated that the agreement 104 can be embodied in any format known in the art. For example, the agreement 104 can be conventionally embodied on paper. The agreement 104 may also be manifested in electronic form, such as an electronic document stored on computer-readable media. Such an electronic agreement may include an acceptance button that the user 108 clicks or presses to indicate agreement acceptance. Other forms the electronic agreements may require a personal identification number or code authenticating the user's identity before acceptance of the agreement 104 is recorded.

In whatever method the agreement 104 is embodied, the agreement 104 recites at least one event dependent on one or more parameters. An event can be anything, such as a price discount, a violation of a device warrantee, or disabling of the device 110. The event is dependent on at least one parameter monitored by an input, such as a sensor on the device 110. An agreement event may be either a penalty or a reward, depending on the conditions set forth in the agreement. For example, the device 110 may be an automobile and the agreement 110 may include an event, the violation of a warrantee, if an oil change is not performed every 3,000 miles. Furthermore, the automobile includes two sensors; one to monitor the occurrence of an oil change and the other to monitor the miles traveled by the car.

Once the agreement 104 is acquiesced by the device provider 106 and the device user 108, a representation of the agreement 104 is embedded into the device 110. In one embodiment of the invention, the agreement representation includes one or more Boolean expressions detailing how various parameters trigger events specified in the agreement. This process may include reformatting the agreement 104 into program code or pseudo-code. In this manner, events stipulated in the agreement 108 are indicated at the device 110. For example, an agreement 104 between the device provider 106 and the device user 108 may require the user 108 to change the device's oil every three months in order maintain the device warrantee. The device 110 may monitor the number of oil changes along with the time of each oil change. If the user 108 does not meet the oil change requirements in the agreement 104, an indication is provided at the device 110.

Along with indicating event occurrences, the device 110 may be configured to enforce the agreement 104 between the device provider 106 and user 108. For example, some or all of the device capabilities may be disabled as a result of an event occurrence stipulated in the agreement 104. In one embodiment of the invention, the device 110 may alert the user 108 that an event specified in the agreement 104 is likely to occur in the near future. Such an alert can help the user 108 may take necessary actions to prevent (or ensure) one or more events specified in the agreement 104 from taking place.

In a particular embodiment of the invention, the device 110 may include a software module comprising machine-executable program code. The software module may be executed at a client and/or server, and may be distributed among various computer nodes in the environment 102.

As discussed further below, the present invention beneficially helps implement agreements 104 between device providers 106 and device users 108 by supplying agreement feedback at the device 110. Event occurrences are indicated at the device 110, thereby efficiently communicating the state of the agreement directly to the device user 108 in a timely manner. The present invention may be utilized to enforce device agreements 104 by changing the functionality of the device 110 in response to event occurrences. In this manner, the device provider 106 can protect itself from agreement violations with minimal expense. The invention offers the device provider 106 the flexibility to choose various device parameters to monitor, as well as the freedom to enforce agreements 104 that may not be legally actionable in court. Moreover, by indicating the likelihood of future agreement events occurring, the device user 108 can conveniently choose various agreement options to follow.

In a particular embodiment of the invention, the environment 102 may include added functionality to inform the device provider 106 when events specified in the agreement 104 have occurred. Such a configuration can include a remote base station 114 adapted to communicate with the device 110. It is contemplated that communications between the device 110 and the base station 114 may be effectuated using various wired and/or wireless communication means known in the art.

The base station 114 is coupled to a provider server 116 via a computer network 118. The computer network 118 may be any network known in the art for effectuating communications between the various nodes within the environment 102. Thus, the network 118 can be a local area network (LAN), a wide area network (WAN), or a combination thereof. It is contemplated that the network 118 may be configured as a public network, such as the Internet, and/or a private network, and may include various topologies and protocols know to those skilled in the art. In other embodiments of the invention, the network 118 is representative of any communication means between the various entities within the environment 102. Once the device provider 106 receives agreement data from the device 110 at the provider server 116, it is free to process the information in any manner desired.

With reference to FIG. 2, an exemplary device 110 contemplated by the present invention is shown. It should be remarked that at least some of the modules shown may be implemented (1) as a sequence of computer executed steps running on a computing system and/or (2) as interconnected machine units within the computing system. The implementation is a matter of choice dependent on the performance requirements of the system implementing the invention. Accordingly, the modules making up the embodiments of the present invention described herein are referred to alternatively as operations, steps, units, or modules.

The device 110 includes an input module 202 coupled to a determining module 204. The input module 202 is configured to collect parameter data from one or more data sources and may be connected, for example, to a sensor 206 or a keypad 208. The sensor 206 may be used for automatic parameter data input, such as distance traveled, and the keypad 208 may be used for manual entry of parameter data, such as certification of engine service. It is contemplated that manual parameter data entry may be restricted to only authorized persons. Furthermore, various data collection configurations may be employed by the present invention. For instance, the input module 202 may sample data at regular time intervals, detect data changes, or receive data using other data collection methods known in the art.

The input module 202 may also aggregate parameter data for storage and/or transmission to the device provider. The device may aggregate, for example, a running average or the maximum and minimum values of the parameter data.

Each data stream from the input module 202 is identified and passed to the determining module 204. The determining module 204 is configured to determine if an event stipulated in the agreement has occurred based on the received data parameters. As mentioned above, the agreement may be translated into program code 112 that is readable by the determining module 204. In a particular embodiment of the invention, the agreement is translated into various Boolean expressions providing either “TRUE” or “FALSE” results when executed. In the example discussed above, where an agreement event is the violation of a warrantee if an oil change is not performed every 3,000 miles, the agreement may be expressed as:
event1=vehicle warrantee
param1=oil change
param2=miles traveled
if (param1=FALSE and param2>3000) then event1=FALSE
   It is contemplated that the parameters of the Boolean expressions may be stateless or stateful. Furthermore, some events may express intermediary device states and are not expiring events.

If an event specified in the agreement code 112 is determined to have occurred, the determining module 204 communicates the occurrence to a notification module 210. The notification module 210 is configured to provide notification at the device that an event specified in the agreement has occurred. The notification may include various visual, auditory and other types of user alerts known in the art.

In a particular embodiment of the invention, the determining module 204 is additionally configured to determine the likelihood that various agreement events will happen in the future. Thus, if the determining module 204 calculates that an event occurrence is likely, it can send such notification to the notification module 210. The notification module 210 can provide warning to the user that an agreement event is likely to occur unless counteractive measures are taken.

The notification module 210 may also be coupled to a communication module 212. The communication module 212 is configured to communicate event notifications and/or parameter data outside the device 110. For example, the communication module 212 may transmit the parameter data to the device provider. As mentioned above, the parameter data may be aggregated at the input module 202. It is contemplated that the parameter data communicated with the device provider can be used as evidence to demonstrate agreement violation.

The communication module 212 may include wireless networking capability and can remotely interact with the device provider's server. It is contemplated that the communication module 212 may be configured to interact with third party entities as well, such as authorized service providers and device brokers.

It is contemplated that the determining module 210 may also be coupled to a control module 214. The control module 214 is configured to enforce the agreement at the device 110. For example, the control module 214 may disable some the capabilities of the device if a particular agreement event occurred. Conversely, the control module may enable device capabilities if another event occurred, as specified in the agreement.

The modules of the device may be operational in a computing system on which the invention may be implemented. Computing systems suitable for use with the invention include, but are not limited to, general purpose computers, special purpose computers, and other state machines. Examples of well known computing system, environments, and/or configuration that may be suitable for use with the invention include, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

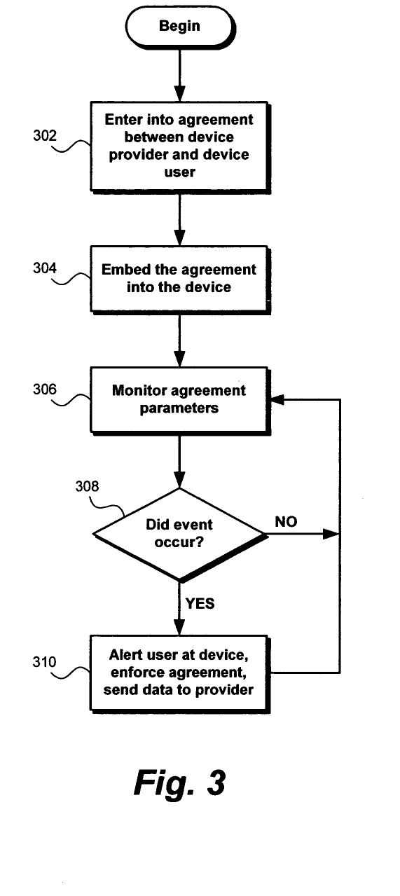

In FIG. 3, an exemplary process contemplated by one embodiment of the present invention is shown. The operations described herein may be specified in computer-executable instructions, such as program modules, being executed by a computer. Generally, program modules include routines, programs, objects, components, data structures, etc. that perform particular tasks or implement particular abstract data types.

The process begins at agreement operation 302. During this operation, a device user and a device provider enter into an agreement containing terms about the device. Since the agreement is later embedded into the device, the agreement may be constructed to utilize parameters not generally employed in conventional agreements. As mentioned above, the agreement may not necessarily be legally enforceable. Thus, the present invention is particularly beneficial in situations where legal action over the agreement is questionable, difficult, or expensive. Once the agreement operation 302 is completed, control passes to embedding operation 304.

At embedding operation 304, the agreement is embedded into the device. The embedding operation 304 involves coding the agreement into machine-readable form such that the device can determine when various events recited in the agreement occur. Typically, the embedding operation is performed automatically by a system implementing the present invention, however it is contemplated that manual intervention be required in some implementations. Once the embedding operation 304 is performed, control passes to monitoring operation 306.

At monitoring operation 306, a sensor or other input device checks one or more parameters. In the example of an automobile discussed above requiring an oil change every 3,000 miles, one sensor may be an odometer that provides mileage parameter information. The other sensor may be an input device accessed by an authorized mechanic changing the engine oil. The mechanic may be required to enter a password or other access code in order to record data into the device. Once input data is received at monitoring operation 306, control passes to determining operation 308.

At determining operation 308, the device determines if an event stipulated in the agreement has occurred based on the monitored parameter(s). As discussed above, the agreement is embedded into the device and can therefore be checked for occurrences of various events that are dependent on monitored parameters. In this manner, the device can determine the state of the agreement with respect to those events that are dependent on monitored parameters. If, at determining operation 308, no event occurrence is detected, control returns to monitoring operation 306. On the other hand, if an event occurrence is detected at determining operation 308, control passes to alerting operation 310.

At alerting operation 310, the device alerts the device user that an event specified by the agreement has occurred. The form of the alert may include various visual, auditory and other types of user alerts known in the art. In one embodiment of the invention, the alerting operation 310 may also be designed to notify the user if an event is likely to occur in the near future. For example, if the automobile warrantee is in danger of being void, the device may alert the user that an oil change should be performed soon so that the warrantee does not become invalid.

As mentioned above, the alerting operation 310 may also enforce the agreement at the device. Therefore, the device configuration may change according to the occurrence of the detected event. It is further contemplated that the device may transmit notification of the event to the device provider or other entities that may require notification of the event occurrence. The outside notification may include parameter data, either aggregated or raw. Once the alerting operation is completed, control returns to monitoring operation 306 and the above process is repeated.

The foregoing description of the invention has been presented for purposes of illustration and description. It is not intended to be exhaustive or to limit the invention to the precise form disclosed, and other modifications and variations may be possible in light of the above teachings. Thus, the embodiments disclosed were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A method for embedding an agreement between a device provider and a device user in a device, the method comprising:
monitoring at least one performance parameter; and
determining if an event specified in the agreement has occurred based on the parameter.

2. The method of claim 1, further comprising if the event occurred, indicating that the event occurred at the device.

3. The method of claim 1, further comprising storing the agreement in the device.

4. The method of claim 1, further comprising enforcing the agreement at the device.

5. The method of claim 4, wherein enforcing the agreement includes disabling at least some of the capabilities of the device if the event occurred.

6. The method of claim 4, wherein enforcing the agreement includes enabling at least some of the capabilities of the device if the event occurred.

7. The method of claim 1, further comprising representing the agreement as a Boolean expression of at least one condition, the condition based on the parameter.

8. The method of claim 1, wherein the event is a violation of the agreement.

9. The method of claim 8, further comprising indicating violation of the agreement on the device.

10. The method of claim 1, further comprising informing the device provider of the event occurrence.

11. The method of claim 1, further comprising restricting access to parameter data.

12. The method of claim 1, further comprising receiving the parameter data by manual entry.

13. The method of claim 1, further comprising transmitting the parameter data to the device provider.

14. A method for embedding an agreement between a software module provider and a software module user in a software module, the method comprising:
monitoring at least one performance parameter; and
determining if an event specified in the agreement has occurred based on the parameter.

15. A device having terms of usage set forth in an agreement between a device provider and a device user, the device comprising:
at least one input module configured to monitor at least one parameter;
a determining module configured to determine if an event specified in the agreement has occurred based on the monitored parameter; and
an alert module configured to indicate that the event occurred.

16. The device of claim 15, wherein the agreement is legally unenforceable.

17. The device of claim 15, wherein the determining module is configured to determine if the event is likely to occur in the near future, and the alert module is configured to indicate that the event is likely to occur in the near future.

18. The device of claim 15, further comprising a data aggregation module configured to aggregate the data from the at least one parameter.

19. The device of claim 18, further comprising a communication module configured to transmit aggregated data from the at least one parameter the device provider.

20. The device of claim 15, further comprising a communication module configured to communicate that the event occurred to the device provider.

21. A computer program product embodied in a tangible media comprising:
computer readable program codes coupled to the tangible media for embedding an agreement between a device provider and a device user in a device, the computer readable program codes configured to cause the program to:
monitor at least one performance parameter;
determine if an event specified in the agreement has occurred based on the parameter; and
if the event occurred, indicate that the event occurred at the device.

22. The computer program product of claim 21, further comprising program code configured to store the agreement in the device.

23. The computer program product of claim 21, further comprising program code configured to enforce the agreement at the device.

24. The computer program product of claim 23, wherein the program code configured to enforce the agreement includes program code configured to disable at least some of the capabilities of the device if the event occurred.

25. The computer program product of claim 23, wherein the program code configured to enforce the agreement includes program code configured to enable at least some of the capabilities of the device if the event occurred.

26. The computer program product of claim 21, wherein the event is a violation of the agreement.

27. The computer program product of claim 26, further comprising program code configured to indicate violation of the agreement on the device.

28. The computer program product of claim 21, further comprising program code configured to inform the device provider of the event occurrence.

29. The computer program product of claim 21, further comprising program code configured to restrict access to parameter data.

30. The computer program product of claim 21, further comprising program code configured to receive the parameter data by manual entry.

31. The computer program product of claim 21, further comprising program code configured to transmit the parameter data to
the device provider.
